(19) United States
(12) Patent Application Publication
(10) Pub. No.: US 2026/0196233 A1
(43) Pub. Date: Jul. 9, 2026

(54) DYNAMIC DETECTION AND SEPARATION OF MULTIPLE VOICES IN AUDIO TRACKS OF CLIENT-AGENT CALLS FOR INDIVIDUALIZED ANALYSIS

(71) Applicant: DISH Network L.L.C., Englewood, CO (US)

(72) Inventor: Christina Joan Sansone, Aurora, CO (US)

(21) Appl. No.: 19/009,317

(22) Filed: Jan. 3, 2025

(51) Int. Cl. G10L 21/0272; G10L 15/26

(52) U.S. Cl. CPC G10L 21/0272; G10L 15/26

(57) ABSTRACT

Systems and methods for dynamically detecting and separating primary and secondary voices within an audio track of a client-agent call. The audio track is analyzed for a primary voice and a secondary voice. In response to identifying a secondary voice in the audio track, the audio track is divided into a primary track that includes the primary voice and a secondary track that includes the secondary voice. The primary conversation transcript can then be generated from the primary track, or the audio track if no secondary voice is detected. Similarly, a secondary conversation transcript is generated from the secondary track. Secondary conversation analytics can be generated based on employment of at least one secondary-conversation artificial intelligence mechanism on the secondary conversation transcript, and primary conversation analytics can be generated based on employment of at least one primary-conversation artificial intelligence mechanism on the primary conversation transcript.

### BACKGROUND

Many companies have telephone helpdesks or support services to provide technical assistance and to address concerns of customers and potential customers. Many of these helpdesks record the phone calls to enable the companies to review their helpdesk procedures and the improve their customer service. Unfortunately, many of the analytical software tools that companies use to analyze the recordings are not useful or practical when there are multiple people talking. It is with respect to these and other considerations that the embodiments described herein have been made.

### BRIEF SUMMARY

Embodiments are directed to the dynamic detection and separation of primary and secondary voices within an audio track of a client-agent call. When an audio track is received, whether a client audio track or an agent audio track, the audio track is analyzed for a primary voice and a secondary voice, if present. In response to failing to identify a secondary voice in the audio track, a primary conversation transcript is generated from the audio track. In response to identifying a secondary voice in the audio track, the audio track is divided into a primary track that includes the primary voice and a secondary track that includes the secondary voice. The primary conversation transcript can then be generated from the primary track. Similarly, a secondary conversation transcript is generated from the secondary track. Secondary conversation analytics can be generated based on employment of at least one secondary-conversation artificial intelligence mechanism on the secondary conversation transcript, and primary conversation analytics can be generated based on employment of at least one primary-conversation artificial intelligence mechanism on the primary conversation transcript.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically detecting and separating multiple voices in audio tracks of client-agent calls for individualized analysis in accordance with embodiments described herein.

FIG. 2 illustrates a block diagram example of an audio content analysis computing system in accordance with embodiments described herein.

FIG. 3 illustrates a logical flow diagram showing one embodiment of a process for dynamically detecting and separating multiple voices in an audio track for individualized analysis of the transcripts of those audio tracks in accordance with embodiments described herein.

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

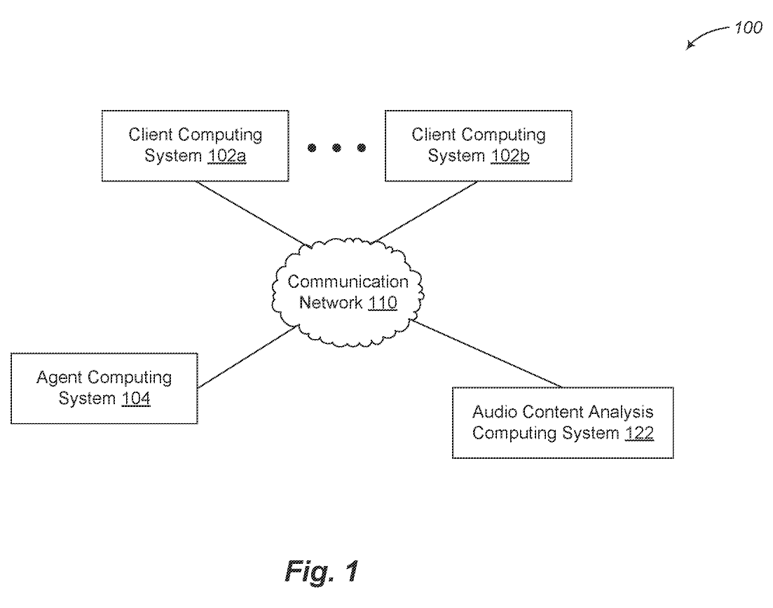

FIG. 1 illustrates a context diagram of an environment 100 for dynamically detecting and separating multiple voices in audio tracks of client-agent calls for individualized analysis in accordance with embodiments described herein. Environment 100 includes client computing systems 102a-102b, agent computing system 104, and audio content analysis computing system 122.

The client computing systems 102a-102b are computing systems or devices in which a client (which may also be referred to as a customer, patron, subscriber, member, or some variation thereof) calls an agent (or receives a call from an agent) via agent computing system 104. This call may be referred to as a client-agent call and may be to discuss technical issues the client is having, discuss termination of membership, discuss changes in service, or other requests for support or assistance. The client-agent call may be a voice call, video call, or other type of telephone or conference call that includes at least a client audio track, stream, or component. The client computing systems 102a-102b may be smartphones, tablets, desktop computers, laptop computers, or other computing devices that can participate in a client-agent call.

The agent computing system 104 is a computing system or device in which one or more agents can make or receive client-agent calls from clients of client computing systems 102a-102b. The agent computing system 104 may be configured to enable multiple agents to participate in a plurality of separate client-agent calls with separate clients. The agent computing system 104 may include one or more computers or computer environments that can support one or more agents participating in client-agent calls.

The audio content analysis computing system 122 is configured to receive a client audio track, an agent audio track, or both, for one client-agent call or a plurality of client-agent calls. In some embodiments, the client audio track and the agent audio track may be generated from or received from previously recorded client-agent calls (e.g., the client-side portion may be recorded separately from the agent-side portion). In other embodiments, the client audio track and the agent audio track may be received or obtained separately in real time as current client-agent calls are being made. The audio content analysis computing system 122 is configured to analyze the client audio track, the agent audio track, or both to determine if an audio track includes a primary voice and a secondary voice, as described herein. If a secondary voice is detected or identified in an audio track, the audio content analysis computing system 122 divides the audio track into a primary audio track and a secondary audio track. In this way, a primary transcript can be generated from the primary audio track and analyzed for various primary metrics or analytics, and a secondary transcript can be generated from the secondary audio track and analyzed for various secondary metrics or analytics, as described herein.

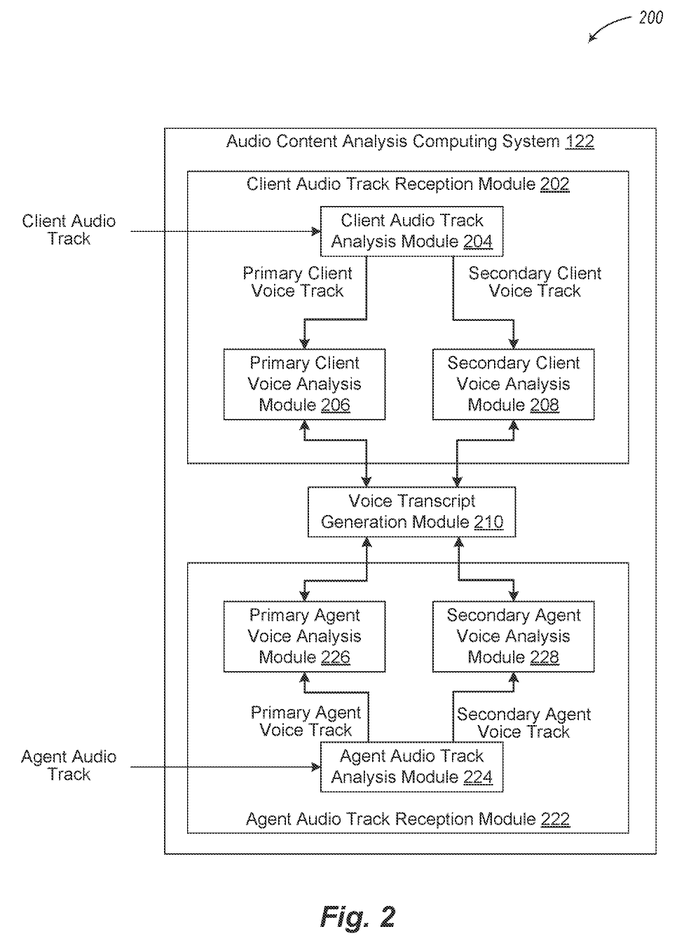

FIG. 2 illustrates a block diagram example 200 of an audio content analysis computing system 122 in accordance with embodiments described herein. The audio content analysis computing system 122 includes a client audio track reception module 202, an agent audio track reception module 220, and a voice transcription generation module 210.

The voice transcription generation module 210 is configured to convert an audio track into a textual representation of the words spoken in the audio track. In various embodiments, the voice transcription generation module 210 may employ one or more computerized audio-to-text mechanisms to generate a transcript of what is said by a person in the audio track. These audio-to-text mechanisms may implement a variety of technologies that analyze the sound waves within the audio track to decern words or phrases uttered by people while the audio track is being recorded.

The client audio track reception module 202 is configured to divide a client audio track into a primary client voice track and a secondary client voice track, and to perform various analytics on transcripts of the tracks. The client audio track reception module 202 may include a client audio track analysis module 204, a primary client voice analysis module 206, and a secondary client voice analysis module 208.

The client audio track analysis module 204 is configured to receive client audio tracks. In some embodiments, the client audio tracks are audio recordings of the client-side of previous client-agent calls. In other embodiments, the client audio tracks are live audio streams of the client-side of current client-agent calls, such as received from client computing systems 102a-102b in FIG. 1. The client audio track analysis module 204 is also configured to identify or detect a primary voice and a secondary voice in the client audio tracks, as described herein. In response to detecting a secondary voice in the client audio track, the client audio track analysis module 204 is configured to divide the client audio track into a primary client voice track and a secondary client voice track. The client audio track analysis module 204 provides the primary client voice track to the primary client voice analysis module 206 and provides the secondary client voice track to the secondary client voice analysis module 208. If a secondary voice is not detected in the client audio track, then the client audio track analysis module 204 does not divide the client audio track and provides the client audio track to the primary client voice analysis module 206 for processing in a same manner as the primary client voice track.

The primary client voice analysis module 206 receives the primary client voice track (or the client audio track if no secondary voice is detected) from the client audio track analysis module 204 and generates a primary client voice transcript from the primary client voice track. In various embodiments, the primary client voice analysis module 206 feeds the primary client voice track through the voice transcript generation module 210 to generate the primary client voice transcript. The primary client voice analysis module 206 is also configured to employ one or more artificial intelligence or machine learning mechanisms on the primary client voice transcript to generate analytics or other information on the primary voice from the client audio track. In some embodiments, the primary client voice analysis module 206 is configured to aggregate the analytics and primary voice information from a plurality of separate client audio tracks from a plurality of separate client-agent calls. In this way, the primary client voice analysis module 206 can generate combined analytics and trends regarding the primary client voices from the plurality of calls.

The secondary client voice analysis module 208 is similar to the primary client voice analysis module 206, but processes the secondary client voice track instead of the primary client voice track. The secondary client voice analysis module 208 receives the secondary client voice track from the client audio track analysis module 204 and generates a secondary client voice transcript from the secondary client voice track. In various embodiments, the secondary client voice analysis module 208 feeds the secondary client voice track through the voice transcript generation module 210 to generate the secondary client voice transcript. The secondary client voice analysis module 208 is also configured to employ one or more artificial intelligence or machine learning mechanisms on the secondary client voice transcript to generate analytics or other information on the secondary voice from the client audio track. In some embodiments, the secondary client voice analysis module 208 is configured to aggregate the analytics and secondary voice information from a plurality of separate client audio tracks from a plurality of separate client-agent calls. In this way, the secondary client voice analysis module 208 can generate combined analytics and trends regarding the secondary client voices from the plurality of calls.

The agent audio track reception module 222 is similar to the client audio track reception module 202, but processes agent audio tracks. The agent audio track reception module 220 is configured to divide an agent audio track into a primary agent voice track and a secondary agent voice track, and to perform various analytics on transcripts of the tracks. In various embodiments, the agent audio track may include a secondary voice if the agent on the call is going through training or a supervisor has been asked to be involved with the call. The agent audio track reception module 222 may include an agent audio track analysis module 224, a primary agent voice analysis module 226, and a secondary agent voice analysis module 228.

The agent audio track analysis module 224 is similar to the client audio track analysis 204, but processes the agent audio track instead of the client audio track. The agent audio track analysis module 224 is configured to receive agent audio tracks. In some embodiments, the agent audio tracks are audio recordings of the agent-side of previous client-agent calls. In other embodiments, the agent audio tracks are live audio streams of the audio-side of current client-agent calls, such as received from agent computing system 104 in FIG. 1. The agent audio track analysis module 224 is then configured to identify or detect a primary voice and a secondary voice in the agent audio tracks, as described herein. In response to detecting a secondary voice in the agent audio track, the agent audio track analysis module 224 is configured to divide the agent audio track into a primary agent voice track and a secondary agent voice track. The agent audio track analysis module 224 provides the primary agent voice track to the primary agent voice analysis module 226 and provides the secondary agent voice track to the secondary agent voice analysis module 228. If a secondary voice is not detected in the agent audio track, then the agent audio track analysis module 224 does not divide the agent audio track and provides the agent audio track to the primary agent voice analysis module 226 for processing in a same manner as the primary agent voice track.

The primary agent voice analysis module 226 is similar to the primary client voice analysis module 206, but processes the primary agent voice track instead of the primary client voice track. The primary agent voice analysis module 226 receives the primary agent voice track from the agent audio track analysis module 224 and generates a primary agent voice transcript from the primary agent voice track. In various embodiments, the primary agent voice analysis module 226 feeds the primary agent voice track through the voice transcript generation module 210 to generate the primary agent voice transcript. The primary agent voice analysis module 226 is also configured to employ one or more artificial intelligence or machine learning mechanisms on the primary agent voice transcript to generate analytics or other information on the primary voice from the agent audio track. In some embodiments, the primary agent voice analysis module 226 is configured to aggregate the analytics and primary voice information from a plurality of separate agent audio tracks from a plurality of separate client-agent calls. In this way, the primary agent voice analysis module 226 can generate combined analytics and trends regarding the primary agent voices from the plurality of calls.

The secondary agent voice analysis module 228 is similar to the secondary client voice analysis module 208, but processes the primary agent voice track instead of the primary client voice track. The secondary agent voice analysis module 228 receives the secondary agent voice track from the agent audio track analysis module 224 and generates a secondary agent voice transcript from the secondary agent voice track. In various embodiments, the secondary agent voice analysis module 228 feeds the secondary agent voice track through the voice transcript generation module 210 to generate the secondary agent voice transcript. The secondary agent voice analysis module 228 is also configured to employ one or more artificial intelligence or machine learning mechanisms on the secondary agent voice transcript to generate analytics or other information on the secondary voice from the agent audio track. In some embodiments, the secondary agent voice analysis module 228 is configured to aggregate the analytics and secondary voice information from a plurality of separate agent audio tracks from a plurality of separate client-agent calls. In this way, the secondary agent voice analysis module 228 can generate combined analytics and trends regarding the secondary agent voices from the plurality of calls.

Although the client audio track reception module 202, the agent audio track reception module 220, and the voice transcription generation module 210 are illustrated separately, embodiments are not so limited. Rather, the functionality of the client audio track reception module 202, the agent audio track reception module 220, and the voice transcription generation module 210 may be employed by a single module or computing component or a plurality of modules or computing components.

Audio content analysis computing system 122 can output or provide the audio transcripts, the determined analytics, or some combination thereof, to one or more users, administrators, or supervisors.

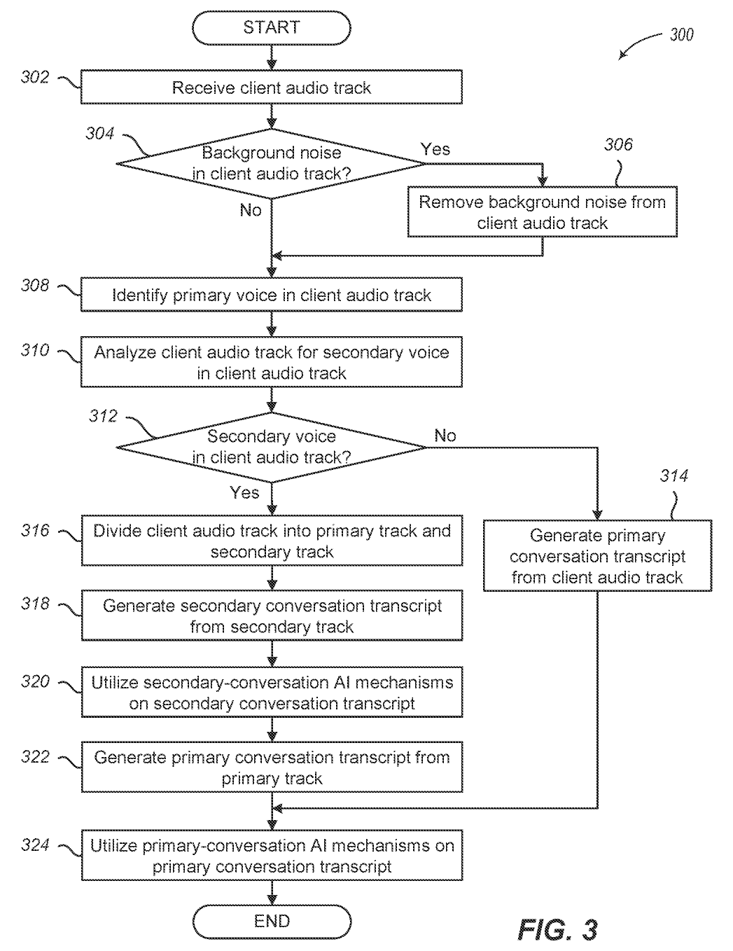

The operation of certain aspects will now be described with respect to FIG. 3. FIG. 3 illustrates a logical flow diagram showing one embodiment of a process 300 for dynamically detecting and separating multiple voices in an audio track for individualized analysis of the transcripts of those audio tracks in accordance with embodiments described herein. Process 300 may be implemented by one or more processors or executed via circuitry on one or more computing devices, such as audio content analysis computing system 122 in FIGS. 1 or 2.

Process 300 begins, after a start block, at block 302 where a client audio track is received. The client audio track may be an audio recording of a client side of a call between a client and an agent (e.g., a helpdesk call, a helpline call, a technical support call, etc.). The call may be an audio-only call, such as a telephone call, or it may be an audiovisual call, such as a video conference call.

Process 300 proceeds, after block 302, to decision block 304, where a determination is made whether background noise is audible in the client audio track. The background noise may be coming from a radio, television, random people talking, etc. that on the client’s premises, which is picked up by client’s microphone and distinguishable within the client audio track. In some embodiments, one or more audio filters or audible thresholds may be employed on the client audio track to determine if background noise is present in the client audio track. For example, the client audio track may be analyzed for sounds having a volume or sound intensity below a background-noise threshold value, but above a minimum threshold value. If a background noise is detected in the client audio track, then process 300 flows to block 306; otherwise, process 300 flows to block 308.

At block 306, the background noise is removed from the client audio track or otherwise suppressed within the client audio track. In some embodiments, the client audio track is modified using one or more audio filters configured to remove the background noise. After block 306, process 300 proceeds to block 308.

At block 308, a primary voice is identified in the client audio track. In various embodiments, the sound waveform that makes up the client audio track is analyzed to identify or detect the primary voice in the client audio track. For example, the primary voice may be selected from the client audio track as that of a first person to speak on the client side of the call. As another example, the person speaking with a highest volume compared to other sounds in the client audio track may be selected as the primary voice. In yet another example, a voice signature of each person talking in the client audio track may be generated and compared to select the primary voice. Each voice signature may be generated from a frequency analysis of the client audio track, a speech cadence of people speaking in the client audio track, a difference in accents between people speaking in the client audio track, or other sound or audio analysis techniques. In at least one embodiment, the primary voice may be for the voice signature that speaks the most words or answers questions of the agent, as compared to other voice signatures that are detected in the client audio track. In some embodiments, phrases, words, questions, or other verbal cues may identify one voice from another within the client audio track.

Process 300 continues, after block 308, at block 310, where the client audio track is analyzed for a secondary voice in the client audio track. For example, the secondary voice may be selected from the client audio track as that of a second person (or any other person to speak after the first person) to speak on the client side of the call. As another example, the person speaking with a lowest volume (or volume lower than the volume of the primary voice) compared to other sounds in the client audio track may be selected as the secondary voice. In yet another example, the voice signature of each person talking in the client audio track may be generated and compared to select the secondary voice, similar to the generation of voice signatures to identify the primary voice in block 308. In at least one embodiment, the secondary voice may be for the voice signature that speaks the fewer words than the voice signature that speaks the most words. In some embodiments, the secondary voice is any voice identifiable within the client audio track that is not associated with the primary voice.

Process 300 proceeds, after block 310, to decision block 312, where a determination is made whether a secondary voice has been identified or detected within the client audio track. If no secondary voice is identified or detected in the client audio track, then only a primary voice is audible in the client audio track. If a secondary voice is in the client audio track, then process 300 flows to block 316; but if no secondary voice is in the client audio track, then process 300 flows to block 314.

At block 314, a primary conversion transcript is generated from the client audio track. Because block 314 is being performed when no secondary voice is identified in the client audio track, then only a primary voice is present in the client audio track and a transcript is generated for that primary voice. In some embodiments, one or more audio-to-text algorithms or mechanisms may be utilized to generate a textual transcript of the conversation or words uttered by the person speaking in the client audio track. After block 314, process 300 proceeds to block 324.

If, at decision block 312, a secondary voice is identified or detected within the client audio track, then process 300 flows from decision block 312 to block 316. At block 316, the client audio track is divided into a primary track (also referred to as a primary client voice track) and a secondary track (also referred to as a secondary client voice track). The primary track is a copy of the client audio track that includes the primary voice, but has the secondary voice removed or suppressed. In this way, the primary track includes all words, phrases, and sounds made by the person who is the primary voice, without the secondary voice being identifiable to detectable within the primary track. In some embodiments, the secondary voice may still be audible within the primary track, but at a volume or sound level that is below a threshold or sufficiently low to not be picked up by conversation transcript generation tools.

The secondary track is a copy of the client audio track that includes the secondary voice, but has the primary voice removed or suppressed. In this way, the secondary track includes all words, phrases, and sounds made by the person who is the secondary voice, without the primary voice being identifiable to detectable within the secondary track. In some embodiments, the primary voice may still be audible within the secondary track, but at a volume or sound level that is below a threshold or sufficiently low to not be picked up by conversation transcript generation tools.

Process 300 proceeds, after block 316, to block 318, where a secondary conversation transcript is generated from the secondary track. In some embodiments, one or more audio-to-text algorithms or mechanisms may be utilized to generate a textual transcript of the conversation or words uttered by the secondary voice in the secondary track.

Process 300 continues, after block 318, at block 320, where one or more secondary conversation artificial intelligence or machine learning mechanisms (which may be generally referred to as secondary conversation AI mechanisms) are utilized or employed on the secondary conversation transcript. In some embodiments, the secondary conversation AI mechanisms may be AI models trained using transcripts of secondary voices from historical client audio tracks. In other embodiments, the secondary conversation AI mechanisms may be AI models trained using a combination of the separate transcripts of primary and secondary voices from historical client audio tracks. In some other embodiments, multiple different secondary conversation AI mechanisms may be generated.

In various embodiments, employment of the secondary conversation AI mechanisms may generate analytics or information regarding the secondary voice in the client audio track, such as is the secondary voice engaging with the primary voice to discuss the topic of the call associated with the client audio track, specific topics of interest to the secondary voice, how influential the secondary voice is to the primary voice, or other information related to the call. Because the secondary voice is separated from the primary voice, employment of the secondary conversation AI mechanisms can provide more insight into the interactions between the secondary voice, the primary voice, and the agent on the other side of the call.

Process 300 proceeds, after block 320, to block 322, where a primary conversation transcript is generated from the primary track. In some embodiments, one or more audio-to-text algorithms or mechanisms may be utilized to generate a textual transcript of the conversation or words uttered by the primary voice in the primary track.

After block 322 or block 314, process 300 continues at block 324, where one or more primary-conversation artificial intelligence or machine learning mechanisms (which may be generally referred to as primary-conversation AI mechanisms) are utilized or employed on the primary conversation transcript. In some embodiments, the primary conversation AI mechanisms may be AI models trained using transcripts of primary voices from historical client audio tracks. In other embodiments, the primary conversation AI mechanisms may be AI models trained using a combination of the separate transcripts of primary and secondary voices from historical client audio tracks.

In some embodiments, the primary-conversation AI mechanisms may include the same trained AI models as the secondary-conversation AI mechanisms. For example, a conversation AI model may be trained from both primary voice transcripts and secondary voice transcripts. In this way, the analytics generated from the utilization of such a conversation AI model takes into account interactions between the primary voice and the secondary voice. In other embodiments, the primary-conversation AI mechanisms may include at least one AI model that is trained differently from the secondary-conversation AI mechanisms. For example, a primary-conversation AI model may be trained from primary voice transcripts, without any secondary voice transcripts, whereas a secondary-conversation AI model may be trained from secondary voice transcripts, without any primary voice transcripts. In this way, the analytics generated from the utilization of such a primary-conversation AI model only considers the primary voice and the analytics generated from the utilization of such a secondary-conversation AI model only considers the secondary voice, which both do not account for the direct interactions between the primary voice and the secondary voice.

After block 324, process 300 terminates or otherwise returns to a calling process to perform other actions.

Although process 300 is described with respect to receiving a client audio track and dividing the client audio track into a primary client track and a secondary client track, embodiments are not so limited. In some embodiments, process 300 may be employed on an agent audio track of an agent side of a call between a client and an agent. In this way, the agent audio track can be divided into a primary agent track and a secondary agent track. By separating the primary agent track from the secondary agent track, agent conversation AI mechanisms may be employed to generate analytics on the agent actually talking to a client and a supervisor of the agent, who may be providing live feedback to the agent as the agent is talking to the client. Similarly, process 300 may be employed on other calls between a first person and a second person where there may be other people conversing with the person on the call.

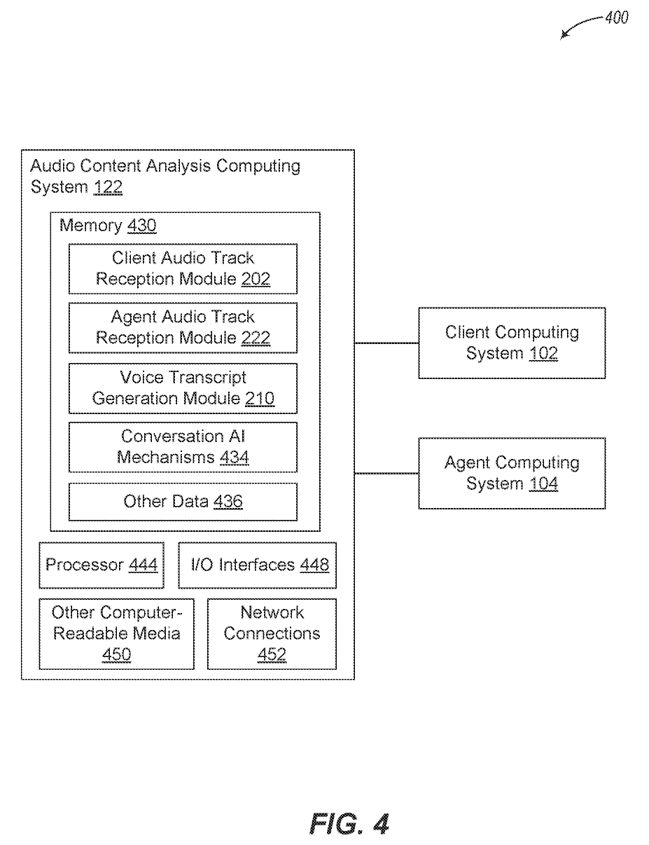

FIG. 4 shows a system diagram that describe various implementations of computing systems for implementing embodiments described herein. System 400 includes an audio content analysis computing system 122, one or more client computing systems 102, and one or more agent computing system 104.

The audio content analysis computing system 122 receives audio tracks from the client computing systems 102, the agent client computing systems 104, or both, related to one or more client-agent calls, and divides the audio track into a primary track and a secondary track. The audio content analysis computing system 122 can then generate separate transcripts for the primary and audio tracks, and then employ one or more artificial intelligence or machine learning mechanisms separately on the primary and secondary transcripts to generate analytics regarding the client-agent call associated with the audio track, as described herein. One or more special-purpose computing systems may be used to implement audio content analysis computing system 122. Accordingly, various embodiments described herein may be implemented in software, hardware, firmware, or in some combination thereof. The audio content analysis computing system 122 may include memory 430, processor 444, I/O interfaces 448, other computer-readable media 450, and network connections 452.

Memory 430 may include one or more various types of non-volatile and/or volatile storage technologies. Examples of memory 430 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 430 may be utilized to store information, including computer-readable instructions that are utilized by processor 444 to perform actions, including embodiments described herein.

Processor 444 includes one or more processors, one or more processing units, programmable logic, circuitry, or one or more other computing components that are configured to perform embodiments described herein or to execute computer instructions to perform embodiments described herein. In some embodiments, a processor system of the audio content analysis computing system 122 may include a single processor 444 that operates individually to perform actions. In other embodiments, a processor system of the audio content analysis computing system 122 may include a plurality of processors 444 that operate to collectively perform actions, such that one or more processors 444 may operate to perform some, but not all, of such actions. Reference herein to “a processor system” of the audio content analysis computing system 122 refers to one or more processors 444 that individually or collectively perform actions. And reference herein to “the processor system” of the audio content analysis computing system 122 refers to 1) a subset or all of the one or more processors 444 comprised by “a processor system” of the audio content analysis computing system 122 and 2) any combination of the one or more processors 444 comprised by “a processor system” of the audio content analysis computing system 122 and one or more other processors 444.

Memory 430 may have stored thereon client audio track reception module 202, agent audio track reception module 222, and voice transcript generation module 210 similar to FIG. 2. Memory 430 may also store one or more conversation AI mechanisms 434 and other data (e.g., operating systems, historic client audio tracks, historic agent audio tracks, client analytics, agent analytics, etc.

Network connections 452 are configured to communicate with other computing devices, such as client computing systems 102 or agent computing systems 104. I/O interfaces 448 may include a keyboard, audio interfaces, video interfaces, or the like. Other computer-readable media 450 may include other types of stationary or removable computer-readable media, such as removable flash drives, external hard drives, or the like.

The client computing systems 102 and the agent computing systems 104 may include computing components or circuitry similar to audio content analysis computing system 122, although for performing separate functionality, but they are not shown in FIG. 4.

The following is a summarization of the claims as originally filed.

A method may be summarized as comprising: receiving a client audio track; identifying a primary voice in the client audio track; analyzing the client audio track to identify a secondary voice in the client audio track; in response to failing to identify a secondary voice in the client audio track, generating a primary conversation transcript from the client audio track; in response to identifying a secondary voice in the client audio track: divide the client audio track into a primary track that includes the primary voice and a secondary track that includes the secondary voice; generating the primary conversation transcript from the primary track; generating a secondary conversation transcript from the secondary track; and generating secondary conversation analytics based on employment of at least one secondary-conversation artificial intelligence mechanism on the secondary conversation transcript; and generating primary conversation analytics based on employment of at least one primary-conversation artificial intelligence mechanism on the primary conversation transcript.

The method may identify the primary voice in the client audio track, including: analyzing the client audio track for a first person to speak; and selecting a voice of the first person to speak as the primary voice.

The method may identify the primary voice in the client audio track, including analyzing the client audio track for a person speaking with a highest volume compared to other sounds in the client audio track; and selecting a voice of the person speaking with the highest volume as the primary voice.

The method may identify the primary voice in the client audio track, including identifying a first voice signature that is distinct from a secondary voice signature; and selecting the first voice signature as the primary voice.

The method may analyze the client audio track to identify a secondary voice in the client audio track, including: analyzing the client audio track for a second person to speak; and identifying the secondary voice as a voice of the second person to speak.

The method may analyze the client audio track to identify a secondary voice in the client audio track, including: analyzing the client audio track for a person speaking with a lowest volume compared to other sounds in the client audio track; and identifying the secondary voice as a voice of the person speaking with the lowest volume.

The method may analyze the client audio track to identify a secondary voice in the client audio track, including: identifying a first voice signature that is distinct from a secondary voice signature; and identifying the secondary voice as the second voice signature.

The method may further comprise: identifying a background noise in the client audio track that is distinct from the primary voice; and suppressing the background noise in the client audio track.

The method may further comprise: receiving an agent audio track of a same conversation as the client audio track; generating an agent conversation transcript from the agent audio track; and generating agent conversation analytics based on employment of at least one agent-conversation artificial intelligence mechanism on the agent conversation transcript. The method may further comprise: employing at least one combined-conversation artificial intelligence mechanism on the agent conversation analytics, the primary conversation analytics, and the secondary conversation analytics to generate combined analytics.

A computing system may be summarized as comprising: at least one memory and a processor system. The at least one memory may be configured to: store computer instructions; and store an audio track of a conversation between an agent and a client. The processor system may be configured to execute the computer instructions to: analyze the audio track to identify a primary voice in the audio track; analyze the audio track to identify a secondary voice in the audio track; divide the audio track into a primary track that includes the primary voice and a secondary track that includes the secondary voice; generate secondary conversation analytics based on employment of at least one secondary-conversation artificial intelligence mechanism on the secondary track; and generate the primary conversation analytics based on employment of the at least one primary-conversation artificial intelligence mechanism on the primary track.

The processor system of the computing system may generate the secondary conversation analytics by being configured to further execute the computer instructions to: generate a secondary conversation transcript from the secondary track; and generate the secondary conversation analytics based on employment of the at least one secondary-conversation artificial intelligence mechanism on the secondary conversation transcript.

The processor system of the computing system may generate the primary conversation analytics by being configured to further execute the computer instructions to: generate a primary conversation transcript from the primary track; and generate the primary conversation analytics based on employment of the at least one primary-conversation artificial intelligence mechanism on the primary conversation transcript.

The processor system of the computing system may analyze the audio track to identify the primary voice in the audio track by being configured to further execute the computer instructions to: analyze the audio track for a first person to speak; and select a voice of the first person to speak as the primary voice.

The processor system of the computing system may analyze the audio track to identify the primary voice in the audio track by being configured to further execute the computer instructions to: analyze the audio track for a person speaking with a highest volume compared to other sounds in the audio track; and select a voice of the person speaking with the highest volume as the primary voice.

The processor system of the computing system may analyze the audio track to identify the primary voice in the audio track by being configured to further execute the computer instructions to: identify a first voice signature that is distinct from a secondary voice signature; and select the first voice signature as the primary voice.

The processor system of the computing system may analyze the audio track to identify the secondary voice in the audio track by being configured to further execute the computer instructions to: analyze the audio track for a second person to speak; and identify the secondary voice as a voice of the second person to speak.

The processor system of the computing system may analyze the audio track to identify the secondary voice in the audio track by being configured to further execute the computer instructions to: analyze the audio track for a person speaking with a lowest volume compared to other sounds in the audio track; and identify the secondary voice as a voice of the person speaking with the lowest volume.

The processor system of the computing system may be configured to further execute the computer instructions to: identify a background noise in the audio track that is distinct from the primary voice; and suppress the background noise in the audio track.

A non-transitory computer-readable medium may be summarized as storing computer instructions that, when executed by at least one processor of a computing system, cause the at least one processor to perform actions, the actions comprising, comprising: receiving an audio track of a first person of a call between the first person and a second person; identifying a primary voice of the first person in the audio track; analyzing the audio track to identify a secondary voice of a third person speaking with the first person; in response to identifying a secondary voice in the audio track: generating a primary track from the audio track to include the primary voice and generating a secondary track from the audio track to include the secondary voice; generating primary conversation analytics based on employment of at least one primary-conversation artificial intelligence mechanism on the primary track; and generating secondary conversation analytics based on employment of at least one secondary-conversation artificial intelligence mechanism on the secondary track; and in response to failing to identify a secondary voice in the audio track: generating the primary conversation analytics based on employment of the at least one primary-conversation artificial intelligence mechanism on the audio track.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a client audio track;
identifying a primary voice in the client audio track;
analyzing the client audio track to identify a secondary voice in the client audio track;
in response to failing to identify a secondary voice in the client audio track:
generating a primary conversation transcript from the client audio track;
in response to identifying a secondary voice in the client audio track:
divide the client audio track into a primary track that includes the primary voice and a secondary track that includes the secondary voice;
generating the primary conversation transcript from the primary track;
generating a secondary conversation transcript from the secondary track; and
generating secondary conversation analytics based on employment of at least one secondary-conversation artificial intelligence mechanism on the secondary conversation transcript; and
generating primary conversation analytics based on employment of at least one primary-conversation artificial intelligence mechanism on the primary conversation transcript.

2. The method of claim 1, wherein identifying the primary voice in the client audio track, comprises:
analyzing the client audio track for a first person to speak; and
selecting a voice of the first person to speak as the primary voice.

3. The method of claim 1, wherein identifying the primary voice in the client audio track, comprises:
analyzing the client audio track for a person speaking with a highest volume compared to other sounds in the client audio track; and
selecting a voice of the person speaking with the highest volume as the primary voice.

4. The method of claim 1, wherein identifying the primary voice in the client audio track, comprises:
identifying a first voice signature that is distinct from a secondary voice signature; and
selecting the first voice signature as the primary voice.

5. The method of claim 1, wherein analyzing the client audio track to identify a secondary voice in the client audio track, comprises:
analyzing the client audio track for a second person to speak; and
identifying the secondary voice as a voice of the second person to speak.

6. The method of claim 1, wherein analyzing the client audio track to identify a secondary voice in the client audio track, comprises:
analyzing the client audio track for a person speaking with a lowest volume compared to other sounds in the client audio track; and
identifying the secondary voice as a voice of the person speaking with the lowest volume.

7. The method of claim 1, wherein analyzing the client audio track to identify a secondary voice in the client audio track, comprises:
identifying a first voice signature that is distinct from a secondary voice signature; and
identifying the secondary voice as the second voice signature.

8. The method of claim 1, further comprising:
identifying a background noise in the client audio track that is distinct from the primary voice; and
suppressing the background noise in the client audio track.

9. The method of claim 1, further comprising:
receiving an agent audio track of a same conversation as the client audio track;
generating an agent conversation transcript from the agent audio track; and
generating agent conversation analytics based on employment of at least one agent-conversation artificial intelligence mechanism on the agent conversation transcript.

10. The method of claim 9, further comprising:
employing at least one combined-conversation artificial intelligence mechanism on the agent conversation analytics, the primary conversation analytics, and the secondary conversation analytics to generate combined analytics.

11. A computing system, comprising:
at least one memory configured to:
store computer instructions; and
store an audio track of a conversation between an agent and a client; and
a processor system configured to execute the computer instructions to:
analyze the audio track to identify a primary voice in the audio track;
analyze the audio track to identify a secondary voice in the audio track;
divide the audio track into a primary track that includes the primary voice and a secondary track that includes the secondary voice;
generate secondary conversation analytics based on employment of at least one secondary-conversation artificial intelligence mechanism on the secondary track; and
generate the primary conversation analytics based on employment of the at least one primary-conversation artificial intelligence mechanism on the primary track.

12. The computing system of claim 11, wherein the processor system generates the secondary conversation analytics by being configured to further execute the computer instructions to:
generate a secondary conversation transcript from the secondary track; and
generate the secondary conversation analytics based on employment of the at least one secondary-conversation artificial intelligence mechanism on the secondary conversation transcript.

13. The computing system of claim 11, wherein the processor system generates the primary conversation analytics by being configured to further execute the computer instructions to:
generate a primary conversation transcript from the primary track; and
generate the primary conversation analytics based on employment of the at least one primary-conversation artificial intelligence mechanism on the primary conversation transcript.

14. The computing system of claim 11, wherein the processor system analyzes the audio track to identify the primary voice in the audio track by being configured to further execute the computer instructions to:
analyze the audio track for a first person to speak; and
select a voice of the first person to speak as the primary voice.

15. The computing system of claim 11, wherein the processor system analyzes the audio track to identify the primary voice in the audio track by being configured to further execute the computer instructions to:
analyze the audio track for a person speaking with a highest volume compared to other sounds in the audio track; and
select a voice of the person speaking with the highest volume as the primary voice.

16. The computing system of claim 11, wherein the processor system analyzes the audio track to identify the primary voice in the audio track by being configured to further execute the computer instructions to:
identify a first voice signature that is distinct from a secondary voice signature; and
select the first voice signature as the primary voice.

17. The computing system of claim 11, wherein the processor system analyzes the audio track to identify the secondary voice in the audio track by being configured to further execute the computer instructions to:
analyze the audio track for a second person to speak; and
identify the secondary voice as a voice of the second person to speak.

18. The computing system of claim 11, wherein the processor system analyzes the audio track to identify the secondary voice in the audio track by being configured to further execute the computer instructions to:
analyze the audio track for a person speaking with a lowest volume compared to other sounds in the audio track; and
identify the secondary voice as a voice of the person speaking with the lowest volume.

19. The computing system of claim 11, wherein the processor system is configured to further execute the computer instructions to:
identify a background noise in the audio track that is distinct from the primary voice; and
suppress the background noise in the audio track.

20. A non-transitory computer-readable medium storing computer instructions that, when executed by at least one processor of a computing system, cause the at least one processor to perform actions, the actions comprising, comprising:
receiving an audio track of a first person of a call between the first person and a second person;
identifying a primary voice of the first person in the audio track;
analyzing the audio track to identify a secondary voice of a third person speaking with the first person;
in response to identifying a secondary voice in the audio track:
generating a primary track from the audio track to include the primary voice and generating a secondary track from the audio track to include the secondary voice;
generating primary conversation analytics based on employment of at least one primary-conversation artificial intelligence mechanism on the primary track; and
generating secondary conversation analytics based on employment of at least one secondary-conversation artificial intelligence mechanism on the secondary track; and
in response to failing to identify a secondary voice in the audio track:
generating the primary conversation analytics based on employment of the at least one primary-conversation artificial intelligence mechanism on the audio track.
